(19) United States
(12) Patent Application Publication
(10) Pub. No.: US 2004/0088690 A1
(43) Pub. Date: May 6, 2004

(54) Method for accelerating a computer application by recompilation and hardware customization

(76) Inventor: Hayim Shaul, Tel Aviv (IL)

Correspondence Address: KATTEN MUCHIN ZAVIS ROSENMAN, 575 MADISON AVENUE, NEW YORK, NY, 10022-2585, US

(21) Appl. No.: 10/623,753

(22) Filed: Jul. 21, 2003

Related U.S. Application Data
(60) Provisional application No. 60/406,113, filed on Aug. 27, 2002.

(51) Int. Cl. G06F 9/45

(52) U.S. Cl. 717/154; 717/145

(57) ABSTRACT

A method for accelerating a compiled application, given its source code, by adapting it to the hardware on which it runs The method can also be applied to applications whose source is not given. The object of this invention is to provide an acceleration method, which is easy and effective to the and user. The invention does not require the user to own a secondary computation device, but attempts to change the software itself to fit best in the user's existing hardware. The method is for accelerating the running time of an application on a central processing unit (CPU) of a computer having a memory and a compiler by adapting the code of the application in an application file to the hardware on which it runs, the method includes the stop of identifying functions in the application to accelerate. Further steps include identifying the hardware on which the application runs, extracting the code of the functions in the application from the application file, changing the code of the functions extracted from the application file to create new code and changing the flow of the application to go through the new code.

### FIELD OF THE INVENTION

The present invention generally relates to the field of compiled computer applications, and in particular, to a method for accelerating a compiled application, with or without being given Its source code, by adapting the application to the hardware on which It runs.

### BACKGROUND OF THE INVENTION

Faster execution for a software application is a common desire of computer users. There are many ways to improve the running time, such as using more efficient programming codes and better compilers, or using a faster CPU, memory or electronic components. The general consensus, however, is that the user cannot change the application itself, and is restricted to the code given by the software provider.

A software developer usually aims to develop an application that runs as fast as possible. To achieve this task he can use one of the many compilers available that provide optimization. Such a compiler takes the code written by the developer, in a computer language readable by humans, and transforms it to a string of 1's and 0's, which represents instructions to the CPU. When switching on the optimization, the compiler applies some techniques on these instructions to exploit special traits of the CPU. Such techniques can be “loop unrolling”, “inline functions” and others. These techniques take into consideration properties of the CPU, such as the number of pipe lines, size of cache, etc, to determine the best techniques to apply.

Unfortunately, different CPU's have different properties, and therefore need different techniques to be applied. Often a technique can be good to one CPU, but disastrous to another. When a developer compiles his code he needs to determine the target of the compilation, namely, the environment, including the CPU, the graphic accelerator, etc., on which the code is intended to run. Needless to say, only those users using a similar environment will derive maximum benefit from the optimization. Other users will benefit loss, or perhaps suffer from the techniques the developer used.

Another problem faced by developers when choosing the compile target, is the need to set the target to be the lowest common denominator (L.C.D.) of all the hardware of their clients. Setting the target to be higher than the lowest common denominator, means that some of the clients will not be able to run the application.

Improved compilers that perform comparisons are known in the art. For example, U.S. Pat. No. 6,519,767 by Carter, et al, discloses a “Compiler and Method for Automatically Building Version Compatible Object Applications.” A compiler automatically builds a new version of an object server to be compatible with an existing version so that client applications built against the existing version are operable with the new version. The existing version object server retains type information relating to its classes and members in a type library. The compiler performs version compatibility analysis by comparing the new version object server against the type information in the existing version's type library. If the compatibility analysis determines that the new and existing versions are compatible, the compiler builds the new version object server to support at least each interface supported by the existing version object server. The compiler further associates version numbers with the new version object server indicative of its degree of compatibility with the existing version object server.

U.S. Pat. No. 6,463,582 by Lethin, et al, teaches “Dynamic Optimizing Object Code Translator for Architecture Emulation and Dynamic Optimizing Object Code Translation Method.” An optimizing object code translation system and method perform dynamic compilation and translation of a target object code on a source operating system while performing optimization. Compilation and optimization of the target code is dynamically executed in real time. A compiler performs analysis and optimizations that Improve emulation relative to template-based translation and Interpretation such that a host processor which processes larger order instructions, such as 32-bit instructions, may emulate a target processor which processes smaller order instructions, such as 16-bit and 8-bit instructions

U.S. Pat. No. 0,311,324 by Smith, et al. entitled “Software Profiler Which Has the Ability to Display Performance Data on a computer screen,” provides a program development tool for identifying critical regions (hot spots) of an application, and providing a programmer with advice with respect to modifications that could improve program performance. However, there is no provision for specific or automatic implementation of any changes.

Therefore, there is a need to overcome the disadvantages of the prior art, and to improve the compilation process to accelerate, and generally improve performance of computer applications

### SUMMARY OF THE INVENTION

Accordingly, it is a principal object of the present invention to provide an acceleration method for computer compiling, which is easy and effective to the end user.

It is another object of the present invention to overcome the requirement for the user to own a secondary computation device.

It is a further object of the present invention to change the software itself to accommodate the user's existing hardware.

A method is disclosed for accelerating the running time of an application on a central processing unit (CPU) of a computer having a memory and a compiler by adapting the code of the application in an application file to the hardware on which it runs, the method includes the step of identifying functions in the application to accelerate. Further steps include identifying the hardware on which the application runs, extracting the code of the functions in the application from the application file changing the code of the functions extracted from the application file to create new code and changing the flow of the application to go through the new code.

The acceleration of applications is achieved even when the source of the application is not given, and it is accomplished by customizing the application to the hardware it runs on. This method, unlike common prior art methods, is performed on the user's computer, as opposed to the developer's computer. This difference allows the method to choose the best optimization techniques for the specific hardware. The method uses four phases. In the first phase the candidate functions to be accelerated are identified. In the second phase the hardware to be use is identified. In the third phase the optimization techniques for the code of the candidate functions and recompiled into better cod. In the fourth phase the new accelerated functions replace the old functions.

The method applies as well to an application whose source is given. In such case replacing original functions with new accelerated functions is easier. In this case the code of the new accelerated functions can be included with the source of the application, as it is complied,

The method can also use human guidance. This guidance is especially usable during the first phase. The user can force, or recommend, certain functions to be accelerated. The method can also be used by developers that wish to produce code that “adjusts” itself to the hardware on which it runs. In such case the method will be embedded in the product being developed.

### BRIEF DESCRIPTION OF THE DRAWINGS

For a better understanding of the invention in regard to the embodiments thereof, reference is made to the accompanying drawings and description, in which like numerals designate corresponding elements or sections throughout, and in which:

FIG. 1 shows the program flow for an application consisting of three functions, with different op-codes in every function, formed in accordance with the principles of the present invention;

FIG. 2 shows the process of an application that is accelerated with the method of the present invention, formed in accordance with the principles of the present invention;

FIG. 3 shows the application in FIG. 5 after accelerating function 2, formed in accordance with the principles of the present invention; and FIG. 4 is a flow chart of the process of an application that is accelerated with the method of the present invention.

### DETAILED DESCRIPTION OF THE PREFERRED EMBODIMENTS

The invention will now be described in connection with certain preferred embodiments with reference to the Following illustrative figures so that it may be more fully understood. References to like numbers indicate like components in all of the figures.

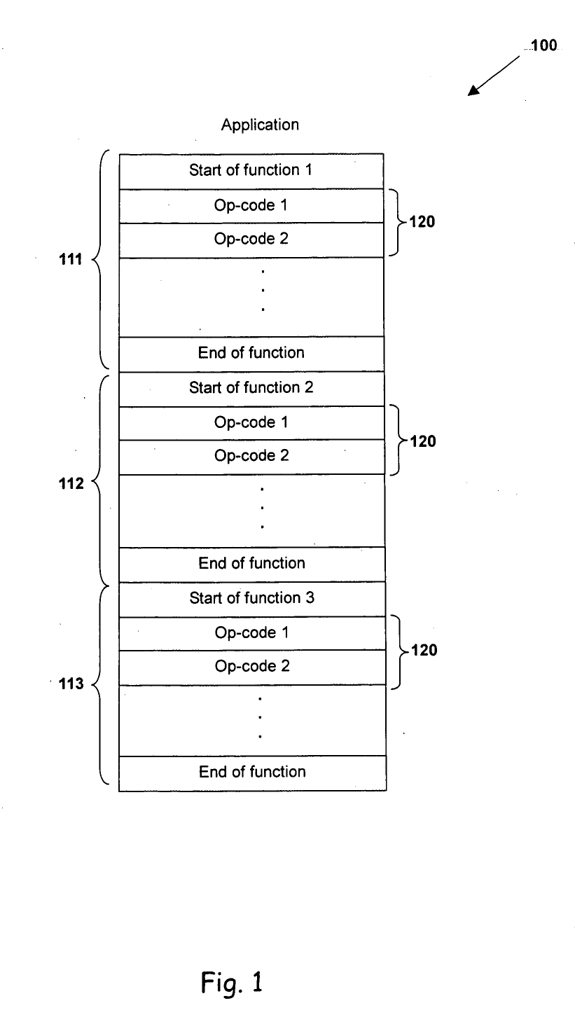

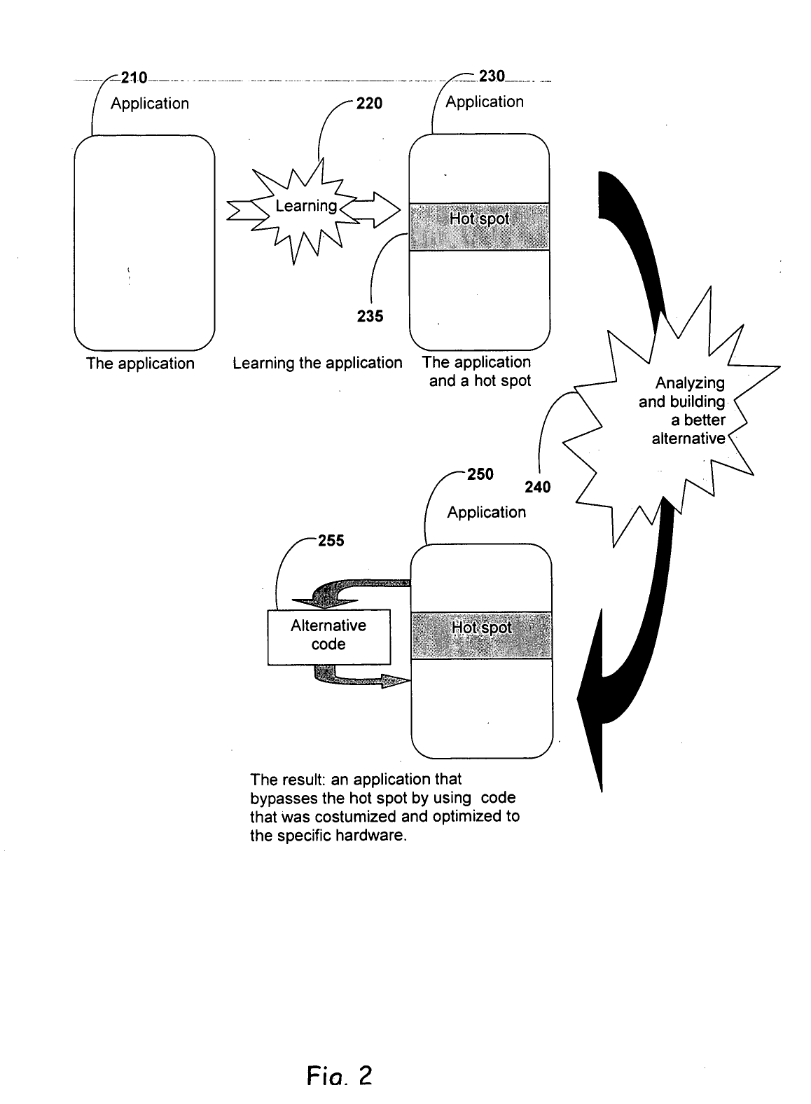

FIG. 1 shows the program flow for an application 100 consisting of three functions 110, with different op-codes 120 in every function, formed in accordance with the principles of the present invention.

The inventive method consists of four phases that can be described as follows. The first phase is to find the slow code. Software applications are collections of one or many functions 110. Functions 110 can be detected and extracted from application 100 by analyzing the binary codes. Commonly used methods include using information embedded within the binary code or examining the code itself and looking for op-code patterns at the beginnings or ends of functions 110. Thus, “hotspot” functions are identified using debug or symbol information embedded in the application file or by gathering statistics to determine the boundaries of the functions.

Most applications tend to spend the largest part of the execution time in very few parts of the codes. The aim of this first phase is to identify these portions and to allocate them as candidates for acceleration. Techniques like the ones used by profilers of all kinds, such as probing the running application and examining its stack, could be used for this purpose. After gathering and analyzing the statistics, a decision is made on functions 110 that comprise the best part of the application to be carried to the next phases.

The second phase is to identify the hardware. There are many applications that identify and analyze the hardware of the computer. Such means can be used in this second phase.

The third phase is to create a better code. Once the code to be optimized has been identified in the first phase, and the hardware of the target computer is known from the first phase, the code to the specific target is extracted using a decompiler and recompiled. Thus, th first phase reveals the slow functions without extracting the code, This recompilation can take advantage of knowing the specific target, and thus use the best optimization techniques. In this recompilation advantage is taken not only of the CPU, but of other hardware components that may be available in the computer.

The recompilation can be done using an existing compiler, or using a special compiler written for this purpose.

FIG. 2 shows the process of an application that is accelerated 200 with the method of the present invention. At first an application is shown pre-analysis 210. Then an analysis 220, or “learning,” is performed on the application and the hardware. Analysis 220 highlights the weaknesses of the application, known as the “hot spot(s)” 230. Hot spot(s) 230 are the pieces of code, which take most of the processing time. During the third phase the specification of the hardware being run is also found. After finding hot spot(s) 230, an alternative is built 240 to these hot spots 230. Building alternative 240 is done by recompiling the code and using optimization techniques best for the specific hardware. Unlike the developer, who developed the application to execute on any machine, this method can customize the application to the user's computer, to get better results. Finally, the alternative to the hot spot(s) is “inserted” 250 into the flow of the application. The result is an application that performs a faster alternative to its hot spot(s) 230, and eventually runs faster.

The fourth phase is to replace the old code with the Improved code. The old function is overwritten in such way that it will now call the new function. This new function can now be linked dynamically or statically to the application, by disassembling the code and linking it again.

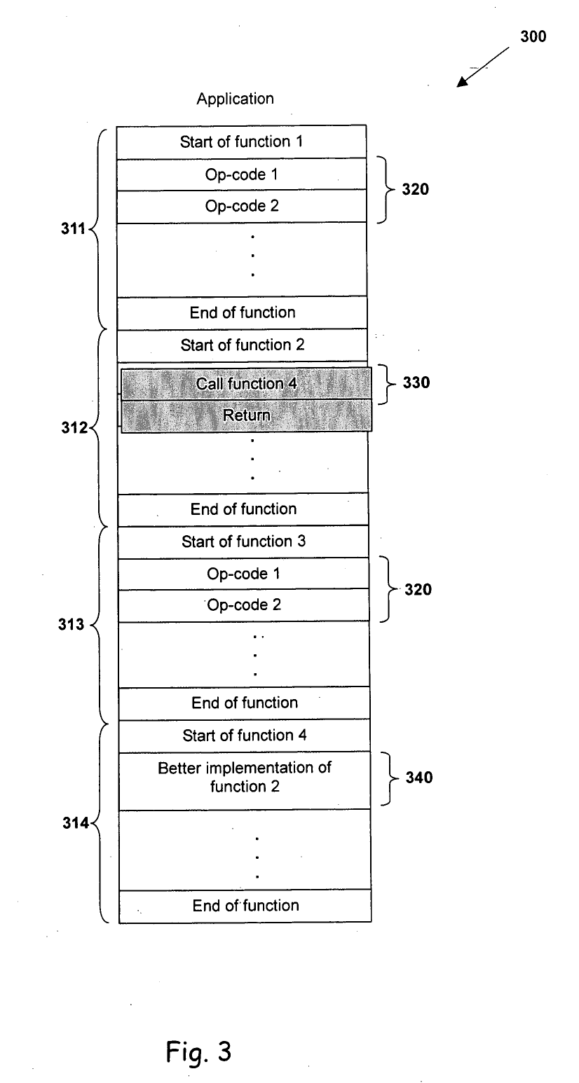

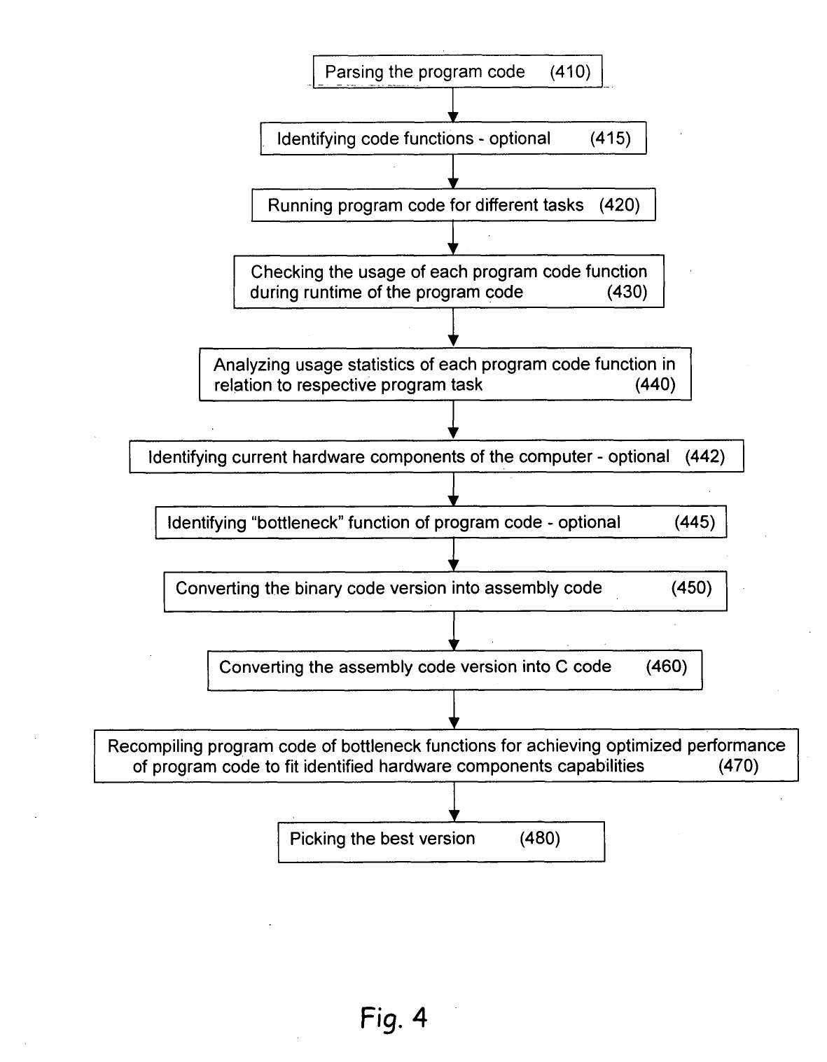

FIG. 3 shows the application in FIG. 1 after accelerating the new function, formed in accordance with the principles of the present invention. Application 300 has four functions: 311; 312; 313; and 314, each having op-codes 320.

An application 300 that has gone through phases one, two and three will now call one of the transformed new functions 340 every time that an old function 330 is called. New function 340 will perform whatever operations are necessary to execute the required task. FIG. 3 shows the result of this process, after modification of the application shown in FIG. 1. In FIG. 3 second function 312 was accelerated. The code of the function was altered so it will call new function 340, which is part of fourth function 314. New function 340 performs the desired task faster, , because it is better optimized to the hardware.

FIG. 4 is a flow chart of the process of an application that is accelerated with the method of the present invention. The first step is parsing of the program code 410 next step, identifying the code functions 415, is optional. This is followed by running the program code for different tasks 420. Checking the usage of each program code function during runtime of the program code 430 is the next step. This is followed by analyzing usage statistics of each program code function in relation to the rest.

Identifying the hardware 442 is an optional step. In this step the type of central processing unit (CPU) that exists in the computer is identified. Also identified is any special hardware, such as a graphic accelerator, math accelerator, or even boards containing general purpose Field Programmable Gate Arrays (FPGA) used for general purpose acceleration, as offered by Celoxica™ and QuickLogic™, for example. If this step is skipped, the optimization of the code in the following steps will not have a full effect. Identification of the CPU and of other special hardware is done by the operating system. The method can extract this information from the operating system. In Linux, for example, by examining the device list, in windows for example by examining the system device manager list, or by probing for the hardware as the operating system does.

Identifying critical regions of the application, i.e., “bottleneck” or “hotspot” functions of the program code may be next 445. This is an optional step. In this step critical regions are identified where the application spends most of its time. This step allows the following steps to concentrate on a small portion of the application, which consumes most of the CPU capacity, instead of optimizing the whole application. If this step is skipped, the algorithm will have to optimize the whole application, which may be overly time-consuming. Also, by performing such profiling of the application, the algorithm will know better how to activate the hardware. For example, an application may spend 90% of its time in procedure A and 10% of its time in procedure B. Optimizing A to run using an FPGA board would improve the running time of the application by a large factor, whereas doing so for B would improve the running time by a very small factor. However, since FPGA-s require a lot of time to be programmed, optimizing A and B to use FPGA-s would make the application run slower. If this step is skipped, the optimizer should generate a few versions of the optimized application, and test which is faster.

This step can be accomplished in a way similar to that of profilers such as VTUNE™. The general idea is to run the application and probe it once every short while to determine the vale of the program counter, i.e., the register pointing to the next instruction the CPU will execute, and the contents of the stack Using such statistics reveals how much time the application spends in each function

An improvement of the present invention over prior art profilers and tuners is in the separation of functions. Profilers generally do not know where a function begins or ends, unless the application is specifically released with such information embedded in its code The algorithm takes advantage of the fact that the compiler puts a certain code in the beginning of each function, and another code at the end of each function. The exact code may be different in different compilers. Usually the compiler saves the value of some registers in the stack at the beginning of the function and restores these register at the end of the function. By locating these two patterns of code, where a function begins and where it ends can be determined

In the next step the binary code of the application is converted into assembly code 450. In the development process of an application, a programmer writes code in a high level language, such as C, C++, etc. A compiler compiles this high language into assembly code. Assembly code is machine dependent and its set of commands is the set of instructions the CPU can perform. The assembly code is actually a detailed version of CPU instructions that perform the code given in the high-language code. Unless the compiler is told to produce a textual file containing the assembly instructions, it produces a binary file containing the assembly instructions in binary code. This binary file Is also called an object file. The code in one or more object files is merged to form the application code. There are some modifications concerning labels and cross references, where a reference in one object file points to a function or variable in another object file. These modifications do not change the code itself.

Since the application code is an immediate translation of the assembly code, it is very easy to obtain the assembly code of an application. Actually, the code of the application is given in assembly code in some binary format The translation into a textual file is straight forward. All debuggers have this capability. Some tools, such as “obidump” in Linux. translate a binary assembly file into a textual assembly file.

To save disk space, or to prevent software piracy, some applications keep the code compressed or encrypted in the file. In such case one cannot obtain the assembly code of the application by reading the file. The algorithm of the present invention solves this problem by performing a memory dump. This means that the algorithm does not read the file to obtain the assembly code, but reads the memory of the running process to obtain its assembly code, by use of a self-extractor. This is always possible since the CPU needs to read the assembly code in order to execute the correct Instruction, so at some point in time the assembly code will be decrypted or decompressed into the memory.

In the next step the assembly code is converted into C code 460. The reason for transforming the assembly code into C code, or any other high-level language, is to, take advantage of C-optimizers. It is possible to skip this step. However skipping this step would make the optimizing step much harder. The problem of converting assembly code to C code is an old problem. Considerable research has been done on this subject and some tools exist for the purpose of solving this problem. For example, the dcc decompiler was developed by Cristina Cifuentes. However, it is not the object of the present invention to produce humanly readable C-code, but rather the present invention produces C-code readable by an automatic optimizer, which is somewhat easier.

Recompiling the C-code 470 is a step wherein the C-code is compiled again into assembly code while applying optimizations that are best for the hardware of the user. All compilers have an option to compile C-code into an optimized assembly code, for example “g++−O.” Optimizations in this step include “loop unrolling”, better ordering of op-codes and much more.

The reason for decompiling the assembly code into C-code, and not directly applying the optimization techniques to the assembly code, is that it is much easier to perform optimization on C code than on assembly code. Another reason is that there are many tools that compile C-code into an optimized assembly code, and there is much research in this area. A further reason is the use of special hardware. Many hardware vendors supply a tool that compiles C-code into code that runs on their hardware. Generating a C-code allows use of these tools as described hereinbelow.

It is possible to perform the optimization directly in the assembly code. In that case there is no need for the de-compilation step.

If the user has some special hardware, e.g. FPGA boards, it is most likely that there is a tool that compiles C-code into code that runs on this hardware, given by the vendor of this hardware, or by some other company. The algorithm of the present invention can use this compiler in this step as a black box to use the special identified hardware to run the C-code. The algorithm does not need to know how to compile C-code for optimizing the code for the identified hardware. It is enough that there exists a “black box” that does this compilation. This black box will be used during this step of the algorithm.

In order to improve the acceleration ratios achieved from special identified hardware using any known optimizing tools for scoring the C-code according to the acceleration it would achieve on the special identified hardware. Such tools can be used to determine what part of the code will be accelerated on the 3special identified hardware. Such a tool can be used as a black box by the algorithm. If such a tool does not exist the algorithm can generate a few versions of optimized code and choose the fastest in the next step.

Picking the best version 480 is the last step. During the previous steps the algorithm might have generated more than one option of accelerated codes. Different versions may include different optimization parameters, when it is not certain which parameter would be the fastest.

The last step would be to run all versions and compare them to determine the fastest version. This version will be the output of the algorithm.

Having described the present invention with regard to certain specific embodiments thereof, it is to be understood that the description is not meant as a limitation, since further modifications will now suggest themselves to those skilled in the art, and it is intended to cover such modifications as fall within the scope of the appended claims.

We claim:

1. A method for accelerating the running time of an application on a central processing unit (CPU) of a computer by adapting the code of the application in an application file to the hardware on which it runs, the method comprising:
identifying hotspot functions in the application to accelerate;
identifying the hardware on which the application runs;
extracting the code of said hotspot functions from the application file;
changing the code of said hotspot functions extracted from said application file to create new code; and
changing the flow of said application to go through said new code.

2. The method of claim 1, wherein said hotspot functions take most of the processing time.

3. The method of claim 1, wherein said step of identifying hotspot functions uses symbol information or debug information embedded in said application file to determine the boundaries of said functions.

4. The method of claim 1, wherein said step of identifying hotspot functions uses code patterns in said application to determine the boundaries of said hotspot functions.

5. The method of claim 1, wherein said step of identifying hotspot functions chooses all said functions to be accelerated.

6. The method of claim 1, wherein said step of identifying hotspot functions uses human guidance to choose said functions to be accelerated.

7. The method of claim 1, wherein said step of identifying hotspot functions further includes the steps of:
running the program code;
checking the usage of each function; and
analyzing usage statistics of each function for selecting functions to accelerate.

8. The method of claim 1, wherein said step of identifying the hardware applies tests on the CPU to identify the CPU.

9. The method of claim 1, wherein said step of identifying the hardware probes for peripheral hardware on the computer.

10. The method of claim 1, wherein said step of identifying the hardware probes for designated acceleration boards on the computer.

11. The method of claim 1, wherein said step of extracting code of said hotspot functions reads the code from said application file.

12. The method of claim 1, wherein said step of extracting the code of said hotspot functions reads the code from the memory when said application is loaded to the memory.

13. The method of claim 1, wherein said step of changing the code produces a code that activates a secondary processing device to apply optimization on said extracted code, wherein the new generated code runs faster on the identified hardware.

14. The method of claim 1, wherein said step of changing the code comprises the steps of: converting a binary code version to assembly code and optimizing the code wherein said code runs faster on the identified hardware.

15. The method of claim 1, wherein said step of changing the code comprises the steps of: converting a binary code version to assembly code, converting the assembly code to C code and optimizing the code to wherein said code runs faster on the identified hardware

16. The method of claim 1, wherein said step of changing the flow of said application changes said application file.

17. The method of claim 1, wherein said step of changing the flow of said application changes the memory after said application is loaded.

18. The method of claim 1, wherein said step of changing the flow of said application uses dynamically loadable modules.

19. The method of claim 1, wherein said step of changing the flow of said application links the application with said new code.

20. The method of claim 1, wherein said step of changing the flow of said application changes the code to jump to said new code.

21. The method of claim 1 wherein more than one version of changed codes is generated using different optimization parameters, and further comprises the step of selecting the best version.

22. The method of claim 23, wherein said step of selecting the best version runs the different code version and selects the fastest version.
